(19) United States
(12) Patent Application Publication
(10) Pub. No.: US 2024/0314452 A1
(43) Pub. Date: Sep. 19, 2024

(54) FOVEATING NEURAL NETWORK

(71) Applicant: Varjo Technologies Oy, Helsinki (FI)

(72) Inventors: Mikko Ollila, Tampere (FI); Mikko Strandborg, Hangonkyla (FI)

(73) Assignee: Varjo Technologies Oy, Helsinki (FI)

(21) Appl. No.: 18/182,815

(22) Filed: Mar. 13, 2023

(51) Int. Cl. H04N 23/84; G06F 3/01; G06N 3/045; G06T 1/20; G06T 3/40; G06T 5/00

(52) U.S. Cl. CPC H04N 23/843; G06F 3/013; G06N 3/045; G06T 1/20; G06T 3/4015; G06T 3/4046; G06T 5/00; G06T 2207/10024; G06T 2207/20084; G06T 2207/30196

(57) ABSTRACT

Disclosed is an imaging system with an image sensor; and at least one processor configured to obtain image data read out by the image sensor; obtain information indicative of a gaze direction of a given user; and utilise at least one neural network to perform demosaicking on an entirety of the image data; identify a gaze region and a peripheral region of the image data, based on the gaze direction of the given user; and apply at least one image restoration technique to one of the gaze region and the peripheral region of the image data.

### TECHNICAL FIELD

The present disclosure relates to imaging systems implementing foveating neural networks. The present disclosure also relates to methods implementing foveating neural networks.

### BACKGROUND

Nowadays, with an increase in the number of images being captured every day, there is an increased demand for developments in image processing. Such a demand is quite high and critical in case of evolving technologies such as immersive extended-reality (XR) technologies which are being employed in various fields such as entertainment, real estate, training, medical imaging operations, simulators, navigation, and the like. In recent developments, application of neural networks is becoming popular for image processing and image enhancing.

However, existing equipment and techniques for utilising neural networks for image processing have several problems associated therewith. Existing techniques utilise separate and different neural networks for dedicatedly processing different regions of a given image. For example, a first neural network may be used for processing a pixel data of a gaze region of the given image and a second neural network may be used for processing the pixel data of a non-gaze region of the given image. Resultantly, such processing is often associated with considerably higher number of coefficients and other image parameters. Moreover, utilising several neural networks simultaneously is extremely computationally intensive and time consuming for a processor. Furthermore, implementing such neural networks require considerably large storage space and, training such neural networks is often time consuming and complex.

Therefore, in light of the foregoing discussion, there exists a need to overcome the aforementioned drawbacks associated with existing equipment and techniques for utilising neural networks for image processing.

### SUMMARY

The present disclosure seeks to provide an imaging system implementing foveating neural network. The present disclosure also seeks to provide a method implementing foveating neural network. An aim of the present disclosure is to provide a solution that overcomes at least partially the problems encountered in prior art.

In a first aspect, an embodiment of the present disclosure provides an imaging system comprising:

an image sensor; and

at least one processor configured to:
obtain image data read out by the image sensor;
obtain information indicative of a gaze direction of a given user; and
utilise at least one neural network to:
   perform demosaicking on an entirety of the image data;
   identify a gaze region and a peripheral region of the image data, based on the gaze direction of the given user; and
   apply at least one image restoration technique to one of the gaze region and the peripheral region of the image data.

In a second aspect, an embodiment of the present disclosure provides a method, the method comprising:
obtaining image data read out by an image sensor;
obtaining information indicative of a gaze direction of a given user; and
utilising at least one neural network for:
   performing demosaicking on an entirety of the image data;
   identifying a gaze region and a peripheral region of the image data, based on the gaze direction of the given user; and
   applying at least one image restoration technique to one of the gaze region and the peripheral region of the image data.

Embodiments of the present disclosure substantially eliminate or at least partially address the aforementioned problems in the prior art, and enable generation of output images by way of utilising the at least one neural network based on user's gaze, without excessively computationally overburdening the at least one processor, the output images emulating image viewing quality and characteristics of human visual system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of an architecture of an imaging system implementing foveating neural network, in accordance with an embodiment of the present disclosure;

FIG. 2A illustrates a single neural network, while FIGS. 2B, 2C, and 2D illustrate a plurality of sub-networks of the single neural network, in accordance with an embodiment of the present disclosure;

FIG. 3 illustrates an exemplary scenario of utilising a first neural network and a second neural network in a cascading manner, in accordance with an embodiment of the present disclosure;

FIG. 4 illustrates an exemplary scenario of utilising a third neural network and a fourth neural network in a parallel manner, in accordance with an embodiment of the present disclosure; and

FIG. 5 illustrates steps of a method implementing foveating neural network, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides an imaging system comprising:

an image sensor; and

at least one processor configured to:
obtain image data read out by the image sensor;
obtain information indicative of a gaze direction of a given user; and
utilise at least one neural network to:
   perform demosaicking on an entirety of the image data;
   identify a gaze region and a peripheral region of the image data, based on the gaze direction of the given user; and
   apply at least one image restoration technique to one of the gaze region and the peripheral region of the image data.

In a second aspect, an embodiment of the present disclosure provides a method, the method comprising:
obtaining image data read out by an image sensor;
obtaining information indicative of a gaze direction of a given user; and
utilising at least one neural network for:
   performing demosaicking on an entirety of the image data;
   identifying a gaze region and a peripheral region of the image data, based on the gaze direction of the given user; and
   applying at least one image restoration technique to one of the gaze region and the peripheral region of the image data.

The present disclosure provides the aforementioned imaging system and method implementing foveating neural network. Herein, the at least one neural network is utilised by the at least one processor (instead of several different neural networks) for performing the demosaicking on full image data, and for applying the at least one image restoration technique on the one of the gaze region and the peripheral region of the image data. Advantageously, processing of the image data performed in this manner is associated with considerably lesser number of coefficients and other image parameters. Moreover, utilising the at least one neural network is neither computationally intensive, nor time consuming, thereby allowing output images to be generated in real time or near real time. Furthermore, implementation of the at least one neural network requires considerably lesser storage space, and requires simpler training of the at least one neural network, as compared to the prior art. The method and the imaging system are simple, robust, fast, reliable, and can be implemented with ease.

It will be appreciated that the at least one neural network may comprise sub-networks (or modules) which could be hardware-accelerated or software-accelerated. In such a case, inference or training of the at least one neural network would be fast, easy, reliable, and efficient. Hardware-accelerated implementation of the at least one neutral network may utilise specialized hardware, such as graphics processing units (GPUs) or application-specific integrated circuits (ASICs). Software-accelerated implementation of the at least one neutral network may utilise a software framework such as PyTorch, TensorFlow, MXNet, or the like.

Throughout the present disclosure, the term “image sensor” refers to a device that detects light from the real-world environment at its photo-sensitive surface, thereby enabling a plurality of pixels arranged on the photo-sensitive surface to capture a plurality of image signals. The plurality of image signals constitute the read out image data of the plurality of pixels. Examples of the image sensor include, but are not limited to, a charge-coupled device (CCD) image sensor, a complementary metal-oxide-semiconductor (CMOS) image sensor, and an infrared image sensor. It will be appreciated that the plurality of pixels could be arranged in a predefined manner (for example, such as a rectangular two-dimensional (2D) grid, a polygonal arrangement, a circular arrangement, an elliptical arrangement, a freeform arrangement, and the like) on the photo-sensitive surface of the image sensor.

It will be appreciated that the image sensor is a part of at least one camera. The at least one processor of the imaging system may be implemented in part as an image signal processor of the at least one camera. The at least one camera could be arranged anywhere in the real-world environment where the user is present, or could be arranged on a remote device present in the real-world environment, or could be arranged on a client device worn by the user on his/her head. Optionally, the at least one camera is implemented as at least one visible light camera. Examples of a given visible light camera include, but are not limited to, a Red-Green-Blue (RGB) camera, a Red-Green-Blue-Alpha (RGB-A) camera, a monochrome camera, a Red-Green-Green-Blue (RGGB) camera, a Red-Yellow-Yellow-Blue (RYYB) camera, a Red-Clear-Clear-Blue (RCCB) camera, a Red-Green-Blue-Infrared (RGB-IR) camera. It will be appreciated that an image sensor of the at least one camera may comprise a Bayer colour filter array (CFA) arranged in front of a plurality of pixels of the image sensor. Such a Bayer CFA could be one of: a 4C Bayer CFA (also referred to as “quad” or “tetra”, wherein a group of 2×2 pixels has a same colour), a 9C Bayer CFA (also referred to as “nona”, wherein a group of 3×3 pixels has a same colour), a 16C Bayer CFA (also referred to as “hexadeca”, wherein a group of 4×4 pixels has a same colour). It will also be appreciated that the at least one camera could be implemented as a combination of the given visible light camera and a depth camera. Examples of the depth camera include, but are not limited to, a Red-Green-Blue-Depth (RGB-D) camera, a ranging camera, a Light Detection and Ranging (LiDAR) camera, a Time-of-Flight (ToF) camera, a Sound Navigation and Ranging (SONAR) camera, a laser rangefinder, a stereo camera, a plenoptic camera, an infrared camera. As an example, the at least one camera may be implemented as the stereo camera.

Herein, the term “client device” refers to a device that is capable at least of displaying a given output image. A given client device could be associated with the user. The imaging system is communicably coupled with the given client device wirelessly and/or in a wired manner. Optionally, the given client device is implemented as a head-mounted display (HMD) device. The term “head-mounted display” device refers to specialized equipment that is configured to present an XR environment to the user when said HMD, in operation, is worn by the user on his/her head. The HMD is implemented, for example, as an XR headset, a pair of XR glasses, and the like, that is operable to display a visual scene of the XR environment to the user. The term “extended-reality” encompasses virtual reality (VR), augmented reality (AR), mixed reality (MR), and the like.

Notably, the at least one processor controls an overall operation of the imaging system. The at least one processor is communicably coupled to at least the image sensor. Optionally, the at least one processor is implemented at least in part as an image signal processor. In an example, the image signal processor may be a programmable digital signal processor (DSP). Additionally or alternatively, optionally, the at least one processor is implemented as a processor of a head-mounted device (HMD) or as a processor of a computing device that is communicably coupled to the HMD. Examples of the computing device include, but are not limited to, a laptop, a desktop computer, a tablet, a phablet, a personal digital assistant, a workstation, a console.

Alternatively, optionally, the at least one processor is implemented as at least one server. In this regard, the at least one server is communicably coupled to a plurality of client devices, where the at least one server obtains the information indicative of the gaze direction of the given user from a given client device. As an example, the at least one server could be a cloud server that provides a cloud computing service.

Throughout the present disclosure, the term “image data” refers to information pertaining to a given pixel of the image sensor, wherein said information comprises one or more of: a colour value of the given pixel, a depth value of the given pixel, a transparency value of the given pixel, a luminance value of the given pixel. Optionally, the image data is in a form of RAW image data. Alternatively, optionally, the image data is in a form of partially processed image data. The image data could be in a given colour space. Optionally, the given colour space is one of: a standard Red-Green-Blue (sRGB) colour space, an RGB colour space, a Luminance and two colour differences (YUV) colour space, a Hue-Chroma-Luminance (HCL) colour space, a Hue-Saturation-Lightness (HSL) colour space, a Hue-Saturation-Brightness (HSB) colour space, a Hue-Saturation-Value (HSV) colour space, a Hue-Saturation-Intensity (HSI) colour space, a Cyan-Magenta-Yellow-Black (CMYK) colour space, a blue-difference and red-difference chroma components (YCbCr) colour space.

Throughout the present disclosure, the term “gaze direction” refers to a direction in which the user's eye is gazing. The gaze direction may be represented by a gaze vector. It will be appreciated that the information indicative of the gaze direction of the given user is obtained from a gaze-tracking means. Optionally, the client device comprises the gaze-tracking means. The term “gaze-tracking means” refers to a specialized equipment for detecting and/or following gaze of the user's eye. The gaze-tracking means could be implemented as contact lenses with sensors, cameras monitoring a position of a pupil of the user's eye, and the like. Such gaze-tracking means are well-known in the art.

Optionally, when identifying the gaze region of the image data, the at least one processor is configured to map the gaze direction of the given user onto the image data. The term “gaze region” of the image data refers to a region of the image data that corresponds to the gaze direction. In other words, the gaze region of the image data corresponds to a gaze region of the output image whose image would be formed on a fovea of the user, when the output image is displayed to the user. Furthermore, the term “peripheral region” of the image data refers to at least a part of a remaining region of the image data excluding the gaze region of the image data. The gaze region of the image data may, for example, be a central region of the image data, a top-left region of the image data, a bottom-right region of the image data, or similar. Typically, the peripheral region of the image data surrounds the gaze region of the image data.

It will be appreciated that the gaze region and the peripheral region of the image data are selected dynamically, based on the gaze direction of the given user. Such a dynamic manner of selecting the gaze region and the peripheral region of the image data emulates a way in which the given user actively focuses within his/her field of view. It will be appreciated that the gaze region of the image data comprises image data (for example, such as pixel values) of some (gaze-contingent) pixels from amongst the plurality of pixels, while the remaining region of the image data comprises image data of at least a part of remaining (non-gaze-contingent) pixels from amongst the plurality of pixels. Optionally, the gaze region may have well-shaped boundaries that resembles any of a circle, a polygon, an ellipse, and the like. Alternatively, the gaze region may have freeform-shaped boundaries, i.e., boundaries that do not resemble any specific shape.

Notably, the at least one neural network is utilised to perform the demosaicking on the entirety of the image data. This means that the demosaicking is performed on the gaze region and the peripheral region of the image data (i.e., irrespective of the gaze direction of the given user). It will be appreciated that the demosaicking is performed to generate (namely, interpolate) a set of complete pixel values (namely, colour values) of each pixel in the plurality of pixels using known pixel values of pixels in the plurality of pixels. In other words, missing/unknown pixel values of some pixels in the image data (due to use of a colour filter with the image sensor) would be generated from available/known pixel values of other pixels in the image data. The demosaicking is to be understood to be a well-known technique that is used for converting RAW image data (captured by the image sensor of the at least one camera), into given colour space data that can further be processed by the at least one processor. Optionally, the given colour space data is one of: standard Red-Green-Blue (sRGB) colour space data, RGB colour space data, Luminance and two colour differences (YUV) colour space data, Hue-Chroma-Luminance (HCL) colour space data, Hue-Saturation-Lightness (HSL) colour space data, Hue-Saturation-Brightness (HSB) colour space data, Hue-Saturation-Value (HSV) colour space data, Hue-Saturation-Intensity (HSI) colour space data, Cyan-Magenta-Yellow-Black (CMYK) colour space data, blue-difference and red-difference chroma components (YCbCr) colour space data. The RGB colour space data is optionally transformed (namely, converted) to any of the other aforesaid colour space data. The demosaicking may involve not only converting the RAW image data into the given colour space data (as discussed above), but also adjusting the given colour space data to match a target display or a data transfer standard.

Throughout the present disclosure, the term “image restoration technique” refers to a technique that improves and enhances an overall visual quality of a region of an output image that corresponds to a given region of the image data, and thus provides an improved visual experience to the given user when the user views said region of the output image. Application of the at least one image restoration technique to the one of the gaze region and the peripheral region of the image data potentially causes said region of the output image to appear sharper, clearer, and overall, of a better quality than without application of the at least one image restoration technique. Hence, an overall visual experience of the user viewing the output image is enhanced. The term “given region” of the image data encompasses the gaze region and/or the peripheral region of the image data.

Optionally, the at least one image restoration technique comprises at least one of: a deblurring technique, a denoising technique, a super-resolution technique, a deblocking technique, an inpainting technique, a motion blur correction technique, an image sharpening technique, a contrast enhancement technique, an edge enhancement technique. The “deblurring technique” refers to an image restoration technique that is used to remove any sort of blurriness (i.e., an effect that causes images to appear unclear or unsharp) from the region of the output image that corresponds to the given region of the image data. The “denoising technique” refers to an image restoration technique that is used to reduce noise levels (i.e., amount of unwanted data signals present in a data related to the image) in the region of the output image that corresponds to the given region of the image data. The “super-resolution technique” refers to an image restoration technique that enhances a resolution of the region of the output image that corresponds to the given region of the image data. The “deblocking technique” refers to an image restoration technique that enables correcting of image artifacts resulting, for example, from an image compression technique in which blocks of a given image are encoded and decoded separately. The “motion blur correction technique” refers to an image restoration technique that enables correcting a motion blur. The term “image sharpening technique” refers to an image restoration technique for increasing an apparent sharpness of (a visual content represented in) the region of the output image that corresponds to the given region of the image data. The “contrast enhancement technique” refers to an image restoration technique for adjusting a relative brightness and darkness of object(s) in a visual scene represented by the given region of the image data, in order to improve visibility of such object(s). The term “edge enhancement” refers to an image restoration technique for enhancing an edge contrast of features represented by the given region of the image data. Such image restoration techniques are well known in the art.

It will be appreciated that the at least one image restoration technique comprises at least one image enhancement technique. Optionally, the at least one image enhancement technique is at least one of: a de-raining technique, a dehazing technique, a colour correction technique, a defect, scratch or debris correction technique, a gamma correction technique, a white balancing technique, a low-light image enhancement technique, a luma and chroma denoising technique, a contrast adjustment technique, a shot noise correction technique, a chromatic aberration correction technique. All the aforementioned techniques are well-known in the art.

Optionally, the one of the gaze region and the peripheral region of the image data is selected based on a type of the at least one image restoration technique being applied. In this regard, some image restoration techniques (for example, such as the deblurring technique and the super-resolution technique) may be more useful and effective to be applied on the gaze region of the image data, whereas other image restoration techniques (for example, such as the denoising technique) may be more useful and effective to be applied on the peripheral region of the image data. This may be because application of some image restoration techniques is more computationally intensive, time consuming, and expensive, as compared to application of the other image restoration techniques. In addition to this, when the given user typically views an image, the given user does not focus on an entirety of the image, but rather the focus of the given user is fixed on a region of the image. Therefore, the gaze region of the image data needs to be processed more significantly in comparison to the peripheral region of the image data to improve an overall visual quality of the image. Moreover, the gaze region of the image data corresponds to a considerably smaller number of pixels, as compared to the remaining region of the image data. Therefore, applying a given image restoration technique selectively to the gaze region or the peripheral region, depending on the type of the given image restoration technique, would be computationally-efficient, time-efficient, and economical. Moreover, the denoising technique could be applied only to the peripheral region, because such a technique typically reduces a resolution of a region of the output image to which it is applied. The technical benefit of applying the denoising technique to the peripheral region is that the user does not perceive any flicker when a sequence of output images is displayed.

It will be appreciated that a given image restoration technique that is applied to the gaze region can also be applied additionally to the peripheral region, when required, and optionally at a coarse level, and vice versa. In other words, the given image restoration technique can also be applied to the entirety of the image data, optionally at different levels. In an example, a same image restoration technique can be first applied to the entirety of the image data at a coarse level, and then the same image restoration technique can only be applied to the gaze region at a fine level. It will also be appreciated that depending on a stage at which the at least one image restoration technique is applied i.e., whether the at least one image restoration technique is applied before the demosaicking or after the demosaicking, the image data on which the at least one image restoration technique is applied could be unprocessed image data (if the demosaicking is not performed yet) or partially processed image data (if the demosaicking is already performed).

In an embodiment, the at least one neural network comprises a single neural network comprising a plurality of sub-networks at different levels, wherein an entirety of the single neural network is utilised to perform demosaicking on the one of the gaze region and the peripheral region of the image data and to apply the at least one image restoration technique to the one of the gaze region and the peripheral region of the image data, to obtain a region of an output image that corresponds to the one of the gaze region and the peripheral region of the image data, and wherein a sub-network from amongst the plurality of sub-networks is utilised to perform demosaicking on another of the gaze region and the peripheral region of the image data, to obtain another region of the output image that corresponds to the another of the gaze region and the peripheral region of the image data.

In this regard, the at least one neural network is implemented as only one neural network (i.e., the single neural network) comprising the plurality of sub-networks. In an example, the single neural network could be implemented as a UNet++ neural network. An architecture of the UNet++ neural network is based on a deep supervised encoder-decoder network, wherein an encoder network is connected to a decoder network using a series of nested dense cross-layers. The UNet++ neural network is well-known in the art. The UNet++ neural network and its utilisation for performing the demosaicking are described, for example, in “A Compact High-Quality Image Demosaicking Neural Network for Edge-Computing Devices” by Shuyu Wang et al., published in Sensors, Vol. 21, Issue 1, 2021, which has been incorporated herein by reference.

Throughout the present disclosure, the term “sub-network” of a given neural network refers to a part of the given neural network comprising a specific number of layers from amongst a plurality of layers of the given neural network. In other words, a given sub-network of a given neural network comprises a subset of a plurality of layers within the given neural network, wherein said subset can function as a separate and small neural network within the (large) given neural network. Notably, different sub-networks of the given neural network are at different levels. Greater the level of the given sub-network, greater is the number of layers in the given sub-network, and greater is the processing capability of the given sub-network, and vice versa. It will be appreciated that greater the level of the given sub-network, greater is the accuracy of performing the demosaicking on the one of the gaze region and the peripheral region, and vice versa. In other words, the demosaicking is performed at a finer level by a sub-network at a first level, as compared to another sub-network at a second level, the first level being higher than the second level.

It will be appreciated that when the at least one neural network is implemented as the UNet++ neural network, greater the number of sub-networks and the level of a given sub-network of the UNet++ neural network, greater are the image encoding capability and the image decoding capability of the UNet++ neural network, and greater is the ability of the UNet++ neural network to perform image restoration tasks. When the level of a given sub-network of the UNet++ neural network is low, a specific task for which said neural network may be trained for (for example, conversion of images in RAW format to images in RGB format while restoring image quality) is not optimally (i.e., accurately) performed. Thus, a multi-level hierarchy of sub-networks within the UNet++ neural network potentially improves its capability and makes it more effective for performing any image processing task (such as image restoration/enhancement).

Optionally, the entirety of the single neural network is utilised to perform the demosaicking on the gaze region of the image data and to apply the at least one image restoration technique (for example, such as the deblurring technique) to the gaze region, to obtain a gaze region of the output image. In this regard, since visual content corresponding to the gaze region is perceived by the given user with a higher visual acuity as compared to visual content corresponding to the peripheral region in the output image, the gaze region of the image data is to be highly accurately and precisely processed and thus, requires a neural network with higher processing capability. Due to this, the entirety of the single neural network is utilized for performing the demosaicking and for applying the at least one image restoration technique on the gaze region. Furthermore, in addition to this, the sub-network is utilised to perform the demosaicking on the peripheral region of the image data, to obtain the peripheral region of the output image. In this regard, since the visual content corresponding to the peripheral region is perceived with a relatively lower visual acuity (due to the human visual system), a neural network with relatively lower processing capability would be sufficient for accurately processing the peripheral region of the image data. Due to this, the sub-network is utilized for performing the demosaicking on the peripheral region.

It will be appreciated that the region of the output image (that corresponds to the one of the gaze region and the peripheral region of the image data) is digitally combined with the another region of the output image (that corresponds to the another of the gaze region and the peripheral region of the image data), to generate an entirety of the output image. The output image thus obtained is highly realistic and accurate. This enhances a viewing experience of the given user when the output image is shown to the given user.

Additionally, optionally, the sub-network is also utilised to apply the at least one image restoration technique to the another of the gaze region and the peripheral region of the image data. In this regard, since it is a sub-network (at a given level from amongst the different levels), the at least one image restoration technique even if also applied to the another of the gaze region and the peripheral region would be applied at a coarse level. In other words, the at least one image restoration technique that is applied to the one of the gaze region and the peripheral region (by utilizing the entirety of the single neural network) would be applied at a finer level, as compared to the at least one image restoration technique that is applied to the another of the gaze region and the peripheral region (by utilizing the sub-network). Advantageously, processing burden on the at least one processor is potentially reduced, as only the sub-network is utilised for the aforesaid application of the at least one image restoration technique instead of the entirety of the single neural network.

Yet additionally, optionally, another sub-network from amongst the plurality of sub-networks is utilised to perform demosaicking on an intermediate region of the image data and to apply the at least one image restoration technique to the intermediate region of the image data, to obtain an intermediate region of the output image that corresponds to the intermediate region of the image data, wherein the intermediate region lies between the gaze region and the peripheral region of the image data, further wherein the another sub-network is at a higher level than the sub-network.

In this regard, there may be an instance when a difference between an image quality of the gaze region of the output image and an image quality of the peripheral region of the output image is considerably drastic (namely, too abrupt). Thus, in such instances, a transition (namely, a boundary) between the two aforesaid regions of the output image may be clearly recognizable (namely, perceivable) by the given user when the output image is displayed to the given user. Thus, a viewing experience of the given user would be unrealistic and non-immersive. The term “intermediate region” of the output images refers to a region of output image that lies in between the gaze region of the output image and the peripheral region of the output image. Optionally, a width of the intermediate region lies in a range of 1 pixel to 300 pixels. More optionally, a width of the intermediate region lies in a range of 1 pixel to 200 pixels. Yet more optionally, a width of the intermediate region lies in a range of 1 pixel to 100 pixels. It will be appreciated that alternatively, the width of the intermediate region may be expressed in terms of degrees, for example, lying in a range of 1 degree to 15 degrees.

It will be appreciated that the intermediate region of the output image (that is obtained by/upon performing the demosaicking and the at least one image restoration technique on the intermediate region of the image data) provides a smooth transition (namely, gradual blending or fusion) between the gaze region of the output image and the peripheral region of the output image. In other words, by generating the intermediate region of the output image, a smooth imperceptible transition is provided between the two aforesaid regions of the output image, as the gaze region of the output image is well-blended with the peripheral region of the output image. Beneficially, this improves immersiveness and realism of user's viewing experience when the output image is presented to the user.

Furthermore, when the another sub-network is at the higher level as compared to the sub-network, the another sub-network applies the demosaicking and the at least one image restoration technique to the intermediate region of the image data at a finer level as compared a level at which the sub-network applies the demosaicking and the at least one image restoration technique to the another of the gaze region and the peripheral region of the image data. It will be appreciated that an effect of a same image restoration technique that is applied to the gaze region, the intermediate region, and the peripheral region would decrease on going from the gaze region towards the peripheral region.

In an example, the another sub-network at a level ‘4’ may be utilised to perform the demosaicking and the at least one image restoration technique on the intermediate region of the image data, whereas the sub-network at a level ‘2’ may be utilised to perform the demosaicking and the at least one image restoration technique on the peripheral region of the image data, the level ‘4’ being higher than the level ‘2’.

In another embodiment, the at least one neural network comprises a first neural network and a second neural network, wherein the first neural network is utilised to perform demosaicking on the entirety of the image data, to obtain a first intermediate image as an output, and wherein an input of the second neural network comprises the first intermediate image, further wherein the second neural network is utilised to apply the at least one image restoration technique to a region of the first intermediate image that corresponds to the one of the gaze region and the peripheral region of the image data, to obtain an output image.

In this regard, the at least one neural network is implemented as two separate neural networks (namely, the first neural network and the second neural network) which operate (namely, work) in a cascading manner i.e., information generated by the first neural network is successively passed to the second neural network for further processing. The term “first intermediate image” refers to an image that is obtained by performing the demosaicking (using the first neural network) on the entirety of the image data. The first intermediate image is served as an input to the second neural network so that the at least one image restoration technique could be applied to the (particular) region of the first intermediate image by the second neural network.

It will be appreciated that prior to applying the at least one image restoration technique, the second neural network identifies the region of the first intermediate image that corresponds to the one of the gaze region and the peripheral region of the image data. Optionally, in this regard, the input of the second neural network further comprises the information indicative of the gaze direction of the given user. Optionally, when identifying said region of the first intermediate image, the at least one processor is configured to map the gaze direction of the given user onto the first intermediate image. It will also be appreciated that by employing the first neural network and the second neural network, processing resources of the at least one processor are utilised judiciously, and thus processing time and overburdening of the at least one processor are minimised.

In an example, the second neural network may be utilised to apply the at least one image restoration technique, for example, the super-resolution technique to a gaze region of the first intermediate image that corresponds to the gaze region of the image data, to obtain the output image. In an example, the second neural network may be utilised to apply the at least one image restoration technique, for example, the denoising technique to a peripheral region of the first intermediate image that corresponds to the peripheral region of the image data, to obtain the output image.

Optionally, the first neural network is also utilised to perform the at least one image restoration technique to the entirety of the image data at a coarse level. In this regard, prior to providing the first intermediate image as the input to the second neural network, the at least one image restoration technique would be applied (at the coarse level) to the entirety of the image data. In this way, an overall visual quality of the gaze region and the peripheral region of the first intermediate image is (already) enhanced, though at the coarse level. Thus, when the second neural network applies the at least one image restoration technique (for example, at a fine level) to the region of the first intermediate image that corresponds to the one of the gaze region and the peripheral region, an image quality of said region would be further enhanced. An image quality of the output image so generated emulates image viewing quality and characteristics of human visual system. In an example, the first neural network may be utilised for performing a given image restoration technique (for example, such as the deblurring technique) on the entirety of the image data at the coarse level, and then the second neural network may be used for performing the given image restoration technique on the gaze region at the fine level.

In yet another embodiment, the at least one neural network comprises a third neural network and a fourth neural network that are to be utilised in parallel,

wherein the third neural network is utilised to perform demosaicking on the entirety of the image data, to obtain a third intermediate image, and wherein the fourth neural network is utilised to apply the at least one image restoration technique to the one of the gaze region and the peripheral region of the image data, to obtain a fourth intermediate image, further wherein the third intermediate image is combined with the fourth intermediate image to generate an output image.

In this regard, the at least one neural network is implemented as the two separate neural networks (namely, the third neural network and the fourth neural network) which operate in a parallel manner i.e., both the aforesaid neural networks operate simultaneously for subsequently generating the output image. In this way, the processing time is significantly reduced. Herein, the term “third intermediate image” refers to an image that is obtained by performing the demosaicking (using the third neural network) on the entirety of the image data. Furthermore, the term “fourth intermediate image” refers to an image that is obtained by applying the at least one image restoration technique (using the fourth neural network) to the one of the gaze region and the peripheral region of the image data. The two aforesaid intermediate images are subsequently utilised for generating the output image. Optionally, unlike the third intermediate image, the fourth intermediate image is in a form of a cropped image as the fourth intermediate image corresponds to the one of the gaze region and the peripheral region of the image data only.

Optionally, when (digitally) combining the third intermediate image with the fourth intermediate image to generate the output image, a pixel in a region of the output image that corresponds to the one of the gaze region and the peripheral region is generated by combining a corresponding pixel of the third intermediate image with a corresponding pixel of the fourth intermediate image. The aforesaid combination of the third intermediate image and the fourth intermediate image could be done with or without utilising any neural network. In an example implementation, the fourth neural network may be utilised to apply a given image restoration technique (for example, the deblurring technique) to the gaze region of the image data, to obtain the fourth intermediate image. Then, the fourth intermediate image would be digitally combined with the third intermediate image for generating the output image.

Optionally, pixels of the third intermediate image are combined with corresponding pixels of the fourth intermediate image by using at least one of: a maximum pixel value, a minimum pixel value, a simple block replacement, a max-min pixel value, a guided filtering, an average pixel value, a weighted average pixel value, a median pixel value. Techniques or algorithms for determining the aforesaid pixel values are well-known in the art. It will be appreciated that such techniques or algorithms are simple, fast and reliable for implementation, and potentially facilitate flicker removal in the output image, without compromising its visual fidelity.

In an example, when the at least one processor uses the maximum pixel value, a maximum of a pixel value of a pixel of the third intermediate image and a pixel value of a corresponding pixel of the fourth intermediate image is selected as a pixel value of a corresponding pixel of the output image. Moreover, when the at least one processor uses the minimum pixel value, a minimum of a pixel value of a pixel of the third intermediate image and a pixel value of a corresponding pixel of the fourth intermediate image is selected as a pixel value of a corresponding pixel of the output image. The minimum pixel value may be used when the third intermediate image and the fourth intermediate image are dark images. When the at least one processor uses the simple block replacement, pixel values of the pixels of the third intermediate image and pixel values of the corresponding pixels of the fourth intermediate image are added, and a pixel block average is determined. The simple block replacement is based on neighbouring pixels of a given pixel. Furthermore, when the at least one processor uses the max-min pixel value, a maximum pixel value of a pixel of the third intermediate image and a minimum pixel value of a pixel of the fourth intermediate image are averaged and selected as a pixel value of a corresponding pixel of the output image.

Optionally, the third neural network is also utilised to perform the at least one image restoration technique to the entirety of the image data at a coarse level. In this regard, the at least one image restoration technique would be applied by the third neural network (at the coarse level) to the entirety of the image data. In this way, an overall visual quality of regions of the third intermediate image corresponding to both the gaze region and the peripheral region is (already) enhanced, though at the coarse level, in the third intermediate image. Thus, when the fourth neural network applies the at least one image restoration technique (for example, at a fine level) to the one of the gaze region and the peripheral region, an image quality of said region would be further enhanced when the fourth intermediate image is combined with the third intermediate image. Therefore, an image quality of the output image so generated emulates image viewing quality and characteristics of human visual system. In an example, the third neural network may be utilised for performing a given image restoration technique (for example, such as the motion blur correction technique) on the entirety of the image data at the coarse level, and then the fourth neural network may be utilised for performing the given image restoration technique on the gaze region at the fine level.

Additionally, optionally, the at least one neural network further comprises at least one other neural network that is to be utilised in parallel with the third neural network and the fourth neural network,

wherein the at least one other neural network is utilised to perform at least one other image restoration technique to the another of the gaze region and the peripheral region of the image data, to obtain at least one other intermediate image,

further wherein the at least one other intermediate image is also combined with the third intermediate image and the fourth intermediate image to generate the output image.

In this regard, the at least one image restoration technique and the at least one other image restoration technique could be applied to the gaze region and the peripheral region, using two different neural networks (namely, the fourth neural network and the at least one other neural network), respectively. Herein, the term “other intermediate image” refers to an image that is obtained by applying the least one other image restoration technique (using the at least one other neural network) on the another of the gaze region and the peripheral region of the image data. The aforesaid intermediate image is subsequently utilised for generating the output image. Optionally, unlike the third intermediate image, the at least one other intermediate image is in a form of a cropped image as the at least one other intermediate image corresponds to the another of the gaze region and the peripheral region of the image data only. In an example, the fourth neural network may be utilised to perform the deblurring technique on the gaze region of the image data, and the at least one other neural network may be utilised to perform the denoising technique on the peripheral region of the image data.

Optionally, when (digitally) combining the at least one other intermediate image with the third intermediate image and the fourth intermediate image to generate the output image,
a pixel in a region of the output image that corresponds to the one of the gaze region and the peripheral region is generated by combining a corresponding pixel of the third intermediate image with a corresponding pixel of the fourth intermediate image, and
a pixel in a region of the output image that corresponds to the another of the gaze region and the peripheral region is generated by combining a corresponding pixel of the at least one other intermediate image with a corresponding pixel of the third intermediate image.

The combination of the at least one other intermediate image with the third intermediate image and the fourth intermediate image could be done with or without utilising any neural network. It will be appreciated that pixels of the third intermediate image could be combined with corresponding pixels of the at least one other intermediate image by using the aforesaid techniques or algorithms (as discussed earlier).

The present disclosure also relates to the method as described above. Various embodiments and variants disclosed above, with respect to the aforementioned first aspect, apply mutatis mutandis to the method.

In an embodiment, the at least one neural network comprises a single neural network comprising a plurality of sub-networks at different levels, and wherein the step of utilising the at least one neural network comprises:
utilising an entirety of the single neural network for performing demosaicking on the one of the gaze region and the peripheral region of the image data and for applying the at least one image restoration technique to the one of the gaze region and the peripheral region of the image data, for obtaining a region of an output image that corresponds to the one of the gaze region and the peripheral region of the image data; and
utilising a sub-network from amongst the plurality of sub-networks for performing demosaicking on another of the gaze region and the peripheral region of the image data, for obtaining another region of the output image that corresponds to the another of the gaze region and the peripheral region of the image data.

Optionally, the step of utilising the at least one neural network further comprises utilising the sub-network also for applying the at least one image restoration technique to the another of the gaze region and the peripheral region of the image data.

Optionally, the step of utilising the at least one neural network further comprises utilising another sub-network from amongst the plurality of sub-networks for performing demosaicking on an intermediate region of the image data and for applying the at least one image restoration technique to the intermediate region of the image data, for obtaining an intermediate region of the output image that corresponds to the intermediate region of the image data, wherein the intermediate region lies between the gaze region and the peripheral region of the image data, further wherein the another sub-network is at a higher level than the sub-network.

In another embodiment, the at least one neural network comprises a first neural network and a second neural network, and wherein the step of utilising the at least one neural network comprises:
utilising the first neural network for performing demosaicking on the entirety of the image data, for obtaining a first intermediate image as an output, and wherein an input of the second neural network comprises the first intermediate image; and
utilising the second neural network for applying the at least one image restoration technique to a region of the first intermediate image that corresponds to the one of the gaze region and the peripheral region of the image data, for obtaining an output image.

Optionally, the step of utilising the at least one neural network further comprises utilising the first neural network for performing the at least one image restoration technique to the entirety of the image data at a coarse level.

In yet another embodiment, the at least one neural network comprises a third neural network and a fourth neural network that are to be utilised in parallel, and wherein the step of utilising the at least one neural network comprises:
utilising the third neural network for performing demosaicking on the entirety of the image data, for obtaining a third intermediate image;
utilising the fourth neural network for applying the at least one image restoration technique to the one of the gaze region and the peripheral region of the image data, for obtaining a fourth intermediate image; and
combining the third intermediate image with the fourth intermediate image for generating an output image.

Optionally, the step of utilising the at least one neural network further comprises utilising the third neural network for performing the at least one image restoration technique to the entirety of the image data at a coarse level.

Optionally, the at least one neural network further comprises at least one other neural network that is to be utilised in parallel with the third neural network and the fourth neural network, and wherein the step of utilising the at least one neural network further comprises:
utilising the at least one other neural network for performing at least one other image restoration technique to the another of the gaze region and the peripheral region of the image data, for obtaining at least one other intermediate image; and
combining the at least one other intermediate image also with the third intermediate image and the fourth intermediate image for generating the output image.

Optionally, the step of combining comprises combining pixels of the third intermediate image with corresponding pixels of the fourth intermediate image by using at least one of: a maximum pixel value, a minimum pixel value, a simple block replacement, a max-min pixel value, a guided filtering, an average pixel value, a weighted average pixel value, a median pixel value.

### DETAILED DESCRIPTION OF THE DRAWINGS

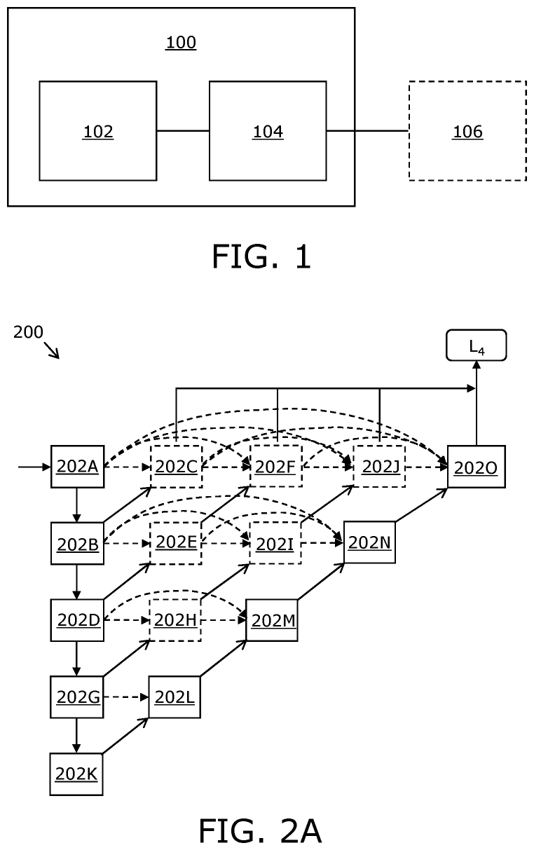

Referring to FIG. 1, illustrated is a block diagram of an architecture of an imaging system 100 implementing foveating neural network, in accordance with an embodiment of the present disclosure. The imaging system 100 comprises an image sensor 102 and at least one processor (depicted as a processor 104) communicably coupled to the image sensor 102. Optionally, the processor 104 is communicably coupled to a client device 106.

It may be understood by a person skilled in the art that FIG. 1 includes a simplified architecture of the imaging system 100, for sake of clarity, which should not unduly limit the scope of the claims herein. It is to be understood that the specific implementation of the imaging system 100 is provided as an example and is not to be construed as limiting it to specific numbers or types of image sensors, processors, and client devices. The person skilled in the art will recognize many variations, alternatives, and modifications of embodiments of the present disclosure.

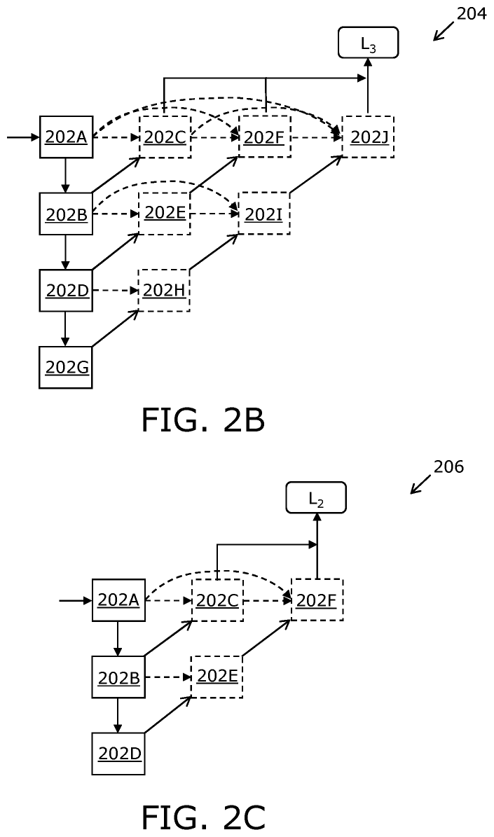

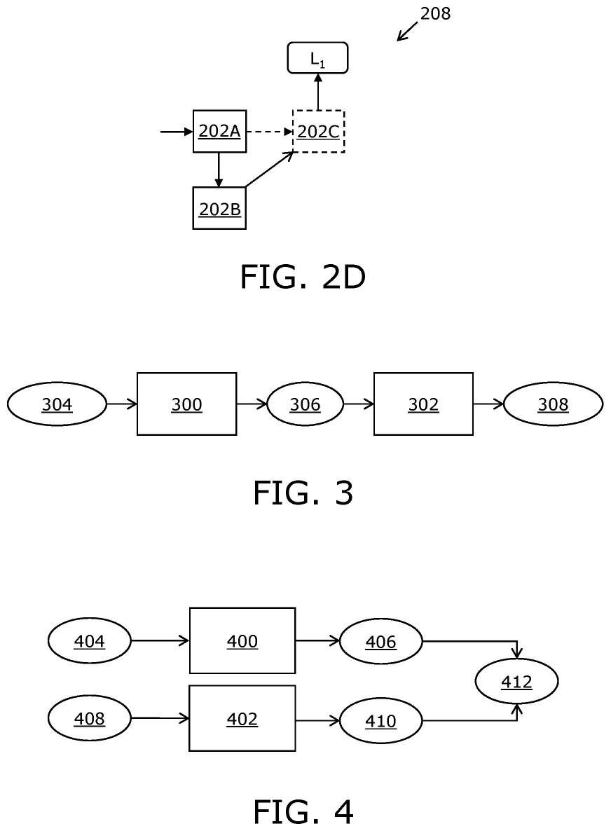

Referring to FIGS. 2A, 2B, 2C, and 2D, FIG. 2A illustrates a single neural network 200, while FIGS. 2B-2D illustrate a plurality of sub-networks (depicted as a first sub-network 204, a second sub-network 206, and a third sub-network 208) of the single neural network 200, in accordance with an embodiment of the present disclosure. With reference to FIG. 2A, the single neural network 200 has four levels, and comprises 15 nodes 202A-2020. With reference to FIG. 2B, the first sub-network 204 has three levels, and comprises 10 nodes 202A-202J. With reference to FIG. 2C, the second sub-network 206 has two levels, and comprises six nodes 202A-202F. With reference to FIG. 2D, the third sub-network 208 has only one level, and comprises three nodes 202A-202C.

Referring to FIG. 3, illustrated is an exemplary scenario of utilising a first neural network 300 and a second neural network 302 in a cascading manner, in accordance with an embodiment of the present disclosure. As shown, an input to the first neural network 300 is an entirety of an image data 304. The first neural network 300 is utilised by at least one processor (not shown) for performing demosaicking on the entirety of the image data 304, to obtain a first intermediate image 306 as an output of the first neural network 300. The first intermediate image 306 is served as input to the second neural network 302. The second neural network 302 is utilised by the at least one processor for applying at least one image restoration technique to one of a gaze region and a peripheral region of the image data, to obtain an output image 308.

Referring to FIG. 4, illustrated is an exemplary scenario of utilising a third neural network 400 and a fourth neural network 402 in a parallel manner, in accordance with an embodiment of the present disclosure. As shown, an input to the third neural network 400 is an entirety of an image data 404. The third neural network 400 is utilised by at least one processor (not shown) for performing demosaicking on the entirety of the image data 404, to obtain a third intermediate image 406 as an output of the third neural network 400. Simultaneously, an input to the fourth neural network 402 is one of a gaze region and a peripheral region of the image data 408. The fourth neural network 402 is utilised by the at least one processor for applying at least one image restoration technique to the one of the gaze region and the peripheral region of the image data 408, to obtain a fourth intermediate image 410 as an output of the fourth neural network 402. Subsequently, the third intermediate image 406 is combined 406 with the fourth intermediate image 410, to obtain an output image 412.

FIGS. 2A-2D, FIG. 3, and FIG. 4 are merely examples, which should not unduly limit the scope of the claims herein. A person skilled in the art will recognize many variations, alternatives, and modifications of embodiments of the present disclosure.

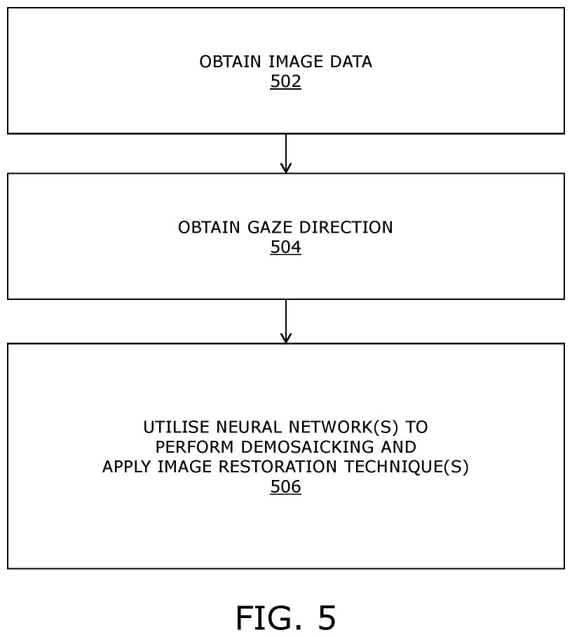

Referring to FIG. 5, illustrated are steps of a method implementing foveating neural network, in accordance with an embodiment of the present disclosure. At step 502, image data read out by an image sensor is obtained. At step 504, information indicative of a gaze direction of a given user is obtained. At step 506, at least one neural network is utilised for performing demosaicking on an entirety of the image data, for identifying a gaze region and a peripheral region of the image data, based on the gaze direction of the given user, and for applying at least one image restoration technique to one of the gaze region and the peripheral region of the image data.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An imaging system comprising:
an image sensor; and
at least one processor configured to:
obtain image data read out by the image sensor;
obtain information indicative of a gaze direction of a given user; and
utilise at least one neural network to:
perform demosaicking on an entirety of the image data;
identify a gaze region and a peripheral region of the image data, based on the gaze direction of the given user; and
apply at least one image restoration technique to one of the gaze region and the peripheral region of the image data.

2. The imaging system of claim 1, wherein the at least one neural network comprises a single neural network comprising a plurality of sub-networks at different levels, wherein an entirety of the single neural network is utilised to perform demosaicking on the one of the gaze region and the peripheral region of the image data and to apply the at least one image restoration technique to the one of the gaze region and the peripheral region of the image data, to obtain a region of an output image that corresponds to the one of the gaze region and the peripheral region of the image data, and wherein a sub-network from amongst the plurality of sub-networks is utilised to perform demosaicking on another of the gaze region and the peripheral region of the image data, to obtain another region of the output image that corresponds to the another of the gaze region and the peripheral region of the image data.

3. The imaging system of claim 2, wherein the sub-network is also utilised to apply the at least one image restoration technique to the another of the gaze region and the peripheral region of the image data.

4. The imaging system of claim 2, wherein another sub-network from amongst the plurality of sub-networks is utilised to perform demosaicking on an intermediate region of the image data and to apply the at least one image restoration technique to the intermediate region of the image data, to obtain an intermediate region of the output image that corresponds to the intermediate region of the image data, wherein the intermediate region lies between the gaze region and the peripheral region of the image data. further wherein the another sub-network is at a higher level than the sub-network.

5. The imaging system of claim 1, wherein the at least one neural network comprises a first neural network and a second neural network, wherein the first neural network is utilised to perform demosaicking on the entirety of the image data, to obtain a first intermediate image as an output, and wherein an input of the second neural network comprises the first intermediate image, further wherein the second neural network is utilised to apply the at least one image restoration technique to a region of the first intermediate image that corresponds to the one of the gaze region and the peripheral region of the image data, to obtain an output image.

6. The imaging system of claim 5, wherein the first neural network is also utilised to perform the at least one image restoration technique to the entirety of the image data at a coarse level.

7. The imaging system of claim 1, wherein the at least one neural network comprises a third neural network and a fourth neural network that are to be utilised in parallel, wherein the third neural network is utilised to perform demosaicking on the entirety of the image data, to obtain a third intermediate image, and wherein the fourth neural network is utilised to apply the at least one image restoration technique to the one of the gaze region and the peripheral region of the image data, to obtain a fourth intermediate image, further wherein the third intermediate image is combined with the fourth intermediate image to generate an output image.

8. The imaging system of claim 7, wherein the third neural network is also utilised to perform the at least one image restoration technique to the entirety of the image data at a coarse level.

9. The imaging system of claim 7, wherein the at least one neural network further comprises at least one other neural network that is to be utilised in parallel with the third neural network and the fourth neural network, wherein the at least one other neural network is utilised to perform at least one other image restoration technique to the another of the gaze region and the peripheral region of the image data, to obtain at least one other intermediate image, further wherein the at least one other intermediate image is also combined with the third intermediate image and the fourth intermediate image to generate the output image.

10. The imaging system of claim 7, wherein pixels of the third intermediate image are combined with corresponding pixels of the fourth intermediate image by using at least one of: a maximum pixel value, a minimum pixel value, a simple block replacement, a max-min pixel value, a guided filtering, an average pixel value, a weighted average pixel value, a median pixel value.

11. A method comprising:
obtaining image data read out by an image sensor;
obtaining information indicative of a gaze direction of a given user; and
utilising at least one neural network for:
performing demosaicking on an entirety of the image data;
identifying a gaze region and a peripheral region of the image data, based on the gaze direction of the given user; and
applying at least one image restoration technique to one of the gaze region and the peripheral region of the image data.

12. The method of claim 11, wherein the at least one neural network comprises a single neural network comprising a plurality of sub-networks at different levels, and wherein the step of utilising the at least one neural network comprises:
utilising an entirety of the single neural network for performing demosaicking on the one of the gaze region and the peripheral region of the image data and for applying the at least one image restoration technique to the one of the gaze region and the peripheral region of the image data, for obtaining a region of an output image that corresponds to the one of the gaze region and the peripheral region of the image data; and
utilising a sub-network from amongst the plurality of sub-networks for performing demosaicking on another of the gaze region and the peripheral region of the image data, for obtaining another region of the output image that corresponds to the another of the gaze region and the peripheral region of the image data.

13. The method of claim 12, wherein the step of utilising the at least one neural network further comprises utilising the sub-network also for applying the at least one image restoration technique to the another of the gaze region and the peripheral region of the image data.

14. The method of claim 12, wherein the step of utilising the at least one neural network further comprises utilising another sub-network from amongst the plurality of sub-networks for performing demosaicking on an intermediate region of the image data and for applying the at least one image restoration technique to the intermediate region of the image data, for obtaining an intermediate region of the output image that corresponds to the intermediate region of the image data, wherein the intermediate region lies between the gaze region and the peripheral region of the image data, further wherein the another sub-network is at a higher level than the sub-network.

15. The method of claim 11, wherein the at least one neural network comprises a first neural network and a second neural network, and wherein the step of utilising the at least one neural network comprises:
utilising the first neural network for performing demosaicking on the entirety of the image data, for obtaining a first intermediate image as an output, and wherein an input of the second neural network comprises the first intermediate image; and
utilising the second neural network for applying the at least one image restoration technique to a region of the first intermediate image that corresponds to the one of the gaze region and the peripheral region of the image data, for obtaining an output image.

16. The method of claim 15, wherein the step of utilising the at least one neural network further comprises utilising the first neural network for performing the at least one image restoration technique to the entirety of the image data at a coarse level.

17. The method of claim 11, wherein the at least one neural network comprises a third neural network and a fourth neural network that are to be utilised in parallel, and wherein the step of utilising the at least one neural network comprises:
utilising the third neural network for performing demosaicking on the entirety of the image data, for obtaining a third intermediate image;
utilising the fourth neural network for applying the at least one image restoration technique to the one of the gaze region and the peripheral region of the image data, for obtaining a fourth intermediate image; and
combining the third intermediate image with the fourth intermediate image for generating an output image.

18. The method of claim 17, wherein the step of utilising the at least one neural network further comprises utilising the third neural network for performing the at least one image restoration technique to the entirety of the image data at a coarse level.

19. The method of claim 17, wherein the at least one neural network further comprises at least one other neural network that is to be utilised in parallel with the third neural network and the fourth neural network, and wherein the step of utilising the at least one neural network further comprises:
utilising the at least one other neural network for performing at least one other image restoration technique to the another of the gaze region and the peripheral region of the image data, for obtaining at least one other intermediate image; and
combining the at least one other intermediate image also with the third intermediate image and the fourth intermediate image for generating the output image.

20. The method of claim 17, wherein the step of combining comprises combining pixels of the third intermediate image with corresponding pixels of the fourth intermediate image by using at least one of: a maximum pixel value, a minimum pixel value, a simple block replacement, a max-min pixel value, a guided filtering, an average pixel value, a weighted average pixel value, a median pixel value.
